(19) United States
(12) Patent Application Publication
(10) Pub. No.: US 2006/0259616 A1
(43) Pub. Date: Nov. 16, 2006

(54) Carrier and protocol indiscriminate edge device and method

(76) Inventor: Roger Sean Lester, Blacksburg, VA (US)

Correspondence Address: SHAWNA J. SHAW, 15151 STRATTON MAJOR CT., CENTERVILLE, VA, 20120, US

(21) Appl. No.: 11/429,196

(22) Filed: May 8, 2006

Related U.S. Application Data
(60) Provisional application No. 60/679,675, filed on May 11, 2005.

(51) Int. Cl. G06F 15/173

(52) U.S. Cl. 709/224

(57) ABSTRACT

A protocol indiscriminate edge device and method for supporting multiple diverse enterprise needs is disclosed. Supported enterprise services may include e.g., traditional PBXs, IP-PBXs, SIP phones, H.323 terminals, etc. In addition, one or more carrier inputs such as TDM, metro-Ethernet, cable, DSL, wireless, etc. may be accepted with the edge device and method. In one aspect, the device comprises one or more input modules, one or more output modules, and a processor. The processor includes a protocol aggregator and bridge operable to translate, manage and direct a plurality of concurrent data streams to multiple customers. In addition, the processor may optionally include a real time database to dynamically configure input and/or output data streams in real time and on-the-fly. The edge device is advantageous in that it allows carriers to support multiple diverse customers through a common access point.

### CLAIM OF PRIORITY

This application claims priority to U.S. Ser. No. 60/679,675, filed May 11, 2005.

### BACKGROUND OF THE INVENTION

1. Field of the Invention

The present invention relates generally to the field of telecommunications and in particular a carrier and protocol indiscriminate device and method for providing service to one or more customers in a telecommunications network.

2. Description of the Related Art

Telecommunications involves the transfer of information such as voice and data over a variety of different networks. Initially, voice and data were transferred over circuit switched networks such as the PSTN. Today, however, more and more communication is taking place over packet switched networks. Voice over IP (VoIP), in particular, is fast becoming the technology of choice to deliver telephony and other services by small, medium and large businesses around the world. In addition to these smaller businesses, a large number of traditional telephony and cable carriers are also implementing unique VoIP solutions to deliver service to customers via a variety of different technologies. These carriers include, but are not limited to, AT&T, Cox Communications, Comcast Communications and Time Warner Communications. In addition, some cable carriers and Local Exchange Carriers (LECs) are focusing on providing “triple-play” or “multi-play” services which deliver: television/video, high-speed internet, telephone (and in some cases wireless) services over a single broadband connection. Such services may be provided to a customer over one or more DSL or HFC carrier lines. To further increase opportunity costs, some carriers are also pursuing the deployment of VoIP to office complexes, high-rise towers, multiple dwelling units (MDUs) and large enterprise customers.

Providing VoIP solutions to a business or enterprise, however, poses particular delivery problems because the carrier must be able to support many protocols and standards for diverse enterprise needs. For example, support may be needed for hard and/or soft phones (e.g., MGCP- or SIP-phones), PBX services, videoconferencing, or other various multimedia applications. Protocols and specifications that may need to be supported may include SS7, MGCP, SIP, H.323, DOCSIS®/PacketCable™ (e.g., NCS or PCMM), 802.11x (all wireless Ethernet standards), wireless GSM, MPLS, Bellcore GR303 standards, and a host of other IP and TDM protocols.

In addition, a carrier's perspective from a physical network standpoint is quite different from the perspective of a business or enterprise. Where a business is concerned with internal wiring, individual phones, and internal network utilization and capacity planning, a telecommunications carrier is concerned with an entirely different set of needs. For example, a carrier has multiple transportation technologies at its disposal that it needs to manage and utilize including, but not limited to: DS0's, DS1s, DS3s, OC-ns, and metro-Ethernet. In addition, a carrier is typically forced to deliver services via a demarcation point assigned by the business or office complex. As a result, carriers are burdened with installing multiple disparate pieces of equipment to accomplish one job-delivering voice, video and data and future VoIP services to different groups of customers. Such equipment includes devices such as gateways, routers, integrated access devices (IADs), media terminal adapters (MTAs), modems, etc. (many of which do not follow a given standard and are developed by different vendors). FIG. 1 shows a simplified current carrier network that visually demonstrates this type of service delivery.

In general, integrated access devices (IADs) typically combine multiple voice and data channels across a single shared access link to a carrier or service provider. The access link may comprise a channelized TDM-based T1 line or may be part of a cable network, broadband wireless link, metro-Ethernet connection, etc. Typically, IADs are installed by the carrier so as to allow the carrier to manage its operation over the carrier's access link. Examples of standalone integrated access devices include the Cisco 2430 series IADs.

Gateways may be broadly described as a network node for interfacing with another network that uses different protocols. Gateways are more complex than routers or switches because they must convert from one stack to another and also may be quite expensive. For example, the AS5350 Universal Gateway by Cisco provides support for H.323, SIP, MGCP and TGCP, and costs upwards of $20,000.

Media Terminal Adapters (MTAs) generally serve as voice gateways in broadband cable networks to interface customer equipment (such as analog phones) with IP networks. MTAs are usually installed at the customer premises and may serve either residential customers or commercial customers. For residential customers, the MTA may be combined with a modem and embedded (i.e., an eMTA) within a set top box for connection to the local network. With respect to enterprises, customer equipment may be connected to the MTA which is then directly connected to the local network. To interface with IP networks, MTAs encapsulate voice packets in RTP/UDP/IP data packets and use e.g., DOCSIS® to establish an IP connection. Provisioning and configuration of MTAs are usually done by the carrier. MTA provisioning configures the MTA with necessary information (such as CMS FQDN, CMS UDP port, etc.) to successfully operate with the PacketCable™ network. Examples of MTAs include the Motorola SBV5120 VoIP MTA and the ARRIS TTM TM102A eMTA. In addition, examples of SIP-based MTAs include Motorola's VT1000 and InnoMedia's 3328Re devices.

To provide an illustration of the problems faced by carriers, in order to support a customer who needs both SIP and traditional PBX support, a carrier currently may need to use multiple diverse pieces of equipment for translation such as gateways, IADs, routers, etc. Moreover, if the carrier happens to be a cable operator (supporting DOCSIS®/PacketCable™), devices such as cable modems, eMTAs, etc. may further be required. If the same carrier also needs to support MGCP phones and H.323 multimedia equipment for other customer(s) in the same building, the carrier may need to provide further additional pieces of equipment to support such services. Thus, it can be seen that supporting diverse services and/or customer equipment for multiple businesses can quickly become burdensome (as well as time consuming in terms of maintenance) for a carrier.

It is apparent that cable carriers in particular face a unique challenge when deploying telecommunication services. In many cases, these carriers have already deployed a combination of TDM, Ethernet, Video and DOCSIS®/PacketCable™ networks. As a result, they are encumbered with an even greater number of elements to support in their network than a traditional telecommunications carrier. In addition, with VoIP delivery in some cable markets, these carriers are finding themselves in the precarious position of being forced to support TDM and VoIP services simultaneously. For example, a typical cable carrier may be forced to provide multiple T1 circuits, data services via DOCSIS®/PacketCable™ and voice services over a combination of TDM, DOCSIS®/PacketCable™ and metro-Ethernet

Another drawback for some carriers is the fact that they are still relying on their old TDM networks to transport voice services while new (standard as well as non-standard) technologies are being rapidly developed and deployed by others. These TDM networks are much slower than cable and optical networks. Although most carriers are likely to eventually shift to IP based networks, they have already invested heavily in their existing infrastructures and therefore also need to make the most efficient use of their current networks. In addition, they need to be able to provide high reliability while migrating over to IP-based networks.

As converged applications such as VoIP become more prevalent, it is anticipated that carriers will use more combinations of IP, VoIP, and TDM protocols to support diverse business and enterprise devices. As a result, carriers face considerable hurdles when attempting to handle multiple diverse networks and rapidly changing technologies. Thus, there exists a need for managing the delivery of different VoIP, multimedia, etc. protocols to office complexes, office towers, multiple dwelling units (MDU's), enterprise businesses, etc.—all who have substantially diverse needs—through a common, simplified access point.

In addition, what is also needed is an edge device and method for interfacing with any carrier input over various types of networks including, but not limited to, metro-Ethernet, T1, cable, DSL or wireless while seamlessly supporting a combination of enterprise services based on e.g., MGCP, SIP, H.323, SS7, NCS, PCMM, etc. Finally, it is desired to. provide a customer edge device and method specifically designed to meet the needs of any telecommunications carrier in a simplified, efficient and cost effective manner.

The protocol indiscriminate edge device and method of the present invention is unique with respect to its application, location within the network (e.g., at the edge of the customer premises) and overall cost and is therefore able to overcome the above described deficiencies of the prior art.

### SUMMARY OF THE INVENTION

According to one aspect of the invention, an edge device is provided at the edge of a customer premises and is configured to accept one or more carrier inputs while securely supporting one or more enterprises and/or services simultaneously. In one embodiment, the edge device comprises a plurality of input and output modules comprising one or more interfaces for various carrier inputs and one or more output interfaces for supporting various types of enterprise services. The input modules are preferably modular and provide the necessary network-specific hardware drivers and interfaces. The edge device also includes a processor comprising a protocol aggregator and bridge. In a further aspect, the processor also comprises a real time database that interfaces between the input modules and the protocol aggregator and bridge. The real time database may be adapted to dynamically configure and manage input data streams in real time and on-the-fly. Preferably, the real time database allows for changes to data streams without interrupting operation of the protocol aggregator and bridge. In addition, the protocol aggregator and bridge further simultaneously manages and supports one or more data streams corresponding to one or more customer services simultaneously. In another aspect, the protocol aggregator and bridge provides simultaneous cross over for the one or more data streams. The output modules of the edge device also preferably include modular interfaces for supporting various types of customer equipment and may include hardware connectors such as RJ-11, RJ-45, USB, etc. Examples of customer equipment include, but are not limited to, analog phones, traditional- and IP-PBXs, H.323 multimedia terminals, SIP-based devices (such as phones or other multimedia equipment), MGCP-based devices (such as MGCP phones), wireless devices, and/or cable equipment, etc.

The device of the present invention is preferably located at the edge of the customer premises. The customer premises may be an office building, a tower, a multiple dwelling unit (MDU), etc. According to one aspect, the edge device may be located e.g., in the basement and/or telco closet of the customer premises. In another aspect, the edge device preferably supports multiple enterprises and associated devices located e.g., within the same building or campus. Such enterprises may require support for diverse devices such as MGCP phones, SIP phones, traditional PBXs, IP-PBXs, POTS, data, video etc. By being located at the edge of the customer premises, the device may be configured (e.g., by the carrier) to support all of the above devices simultaneously for multiple customers with minimal intrusion. In this way, the carrier can support multiple customer needs simultaneously via a common access point. In addition, because multiple protocols are supported, customers are provided with a wider variety of service options and carriers, in turn, are provided with more business opportunities (e.g., in terms of being able to support more customers).

### BRIEF DESCRIPTION OF THE DRAWINGS

FIG. 1 shows a generalized current carrier network.

FIG. 2 shows a generalized carrier network according to the present invention

FIG. 3 shows a detailed description of the services that the edge device may support.

FIG. 4 shows a flow chart of the software cross-connect of the present invention.

FIG. 5 shows a modular configuration of the edge device of the present invention.

### DETAILED DESCRIPTION OF EMBODIMENTS OF THE INVENTION

The present invention will now be described with respect to one or more particular embodiments of the invention. The following detailed description is provided to give the reader a better understanding of certain details of embodiments of the invention depicted in the figures, and is not intended as a limitation on the full scope of the invention, as broadly disclosed herein.

For purposes of this disclosure, it is understood that “a” means one or more, “carrier” means any service provider including telecommunications carriers, internet service providers, etc., “customer” means any residential or business customer, “data stream” means any stream of information encompassing voice, video and/or data traffic, “enterprise” may be used to refer to either a business or residence, “network” refers to any physical or non-physical communication path, and “VoIP” includes voice as well as data and/or multimedia communication.

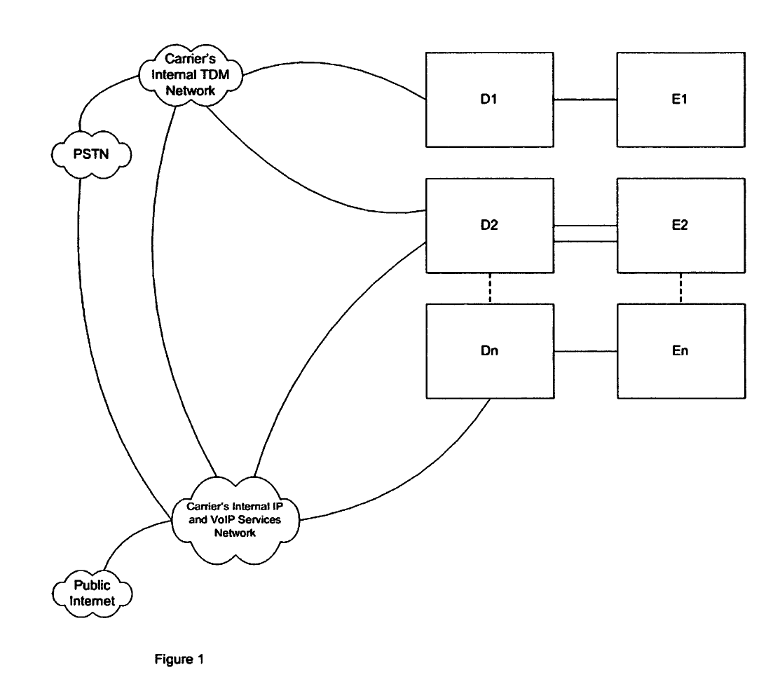

FIG. 1 illustrates, in block diagram form, a generalized current carrier network. As represented in the figure, a large number of devices (D₁₋ₙ) are required to interface with diverse TDM, IP and VoIP carrier inputs. (TDM inputs are generally carried by DS0, DS1, DS3, FXS, FXO or OC-n transportation technologies and IP/VoIP inputs are generally carried by DS1, DS3, OC-n, wireless or metro-Ethernet transportation technologies.) Although only one device is shown for each enterprise, devices (D₁₋ₙ) may include any number of disparate routers, gateways, (IADs), modems, (MTAs), etc. Each device (Dₙ) is typically configured for a particular type of input/interface from the carrier and is not capable of interchangeably receiving different types of carrier inputs/interfaces. As demonstrated in this figure, D₁ receives TDM inputs, D₂ receives both TDM and IP inputs, and Dₙ receives IP inputs. It is to be understood, however, that many other combinations are possible and the inputs and devices as exemplified in FIG. 1 are not meant to be limited to those shown. Additional devices (D₁₋ₙ) may also be required for supporting different types of services on the “enterprise” side such as data, VoIP, PBX, POTS etc. For example, Enterprise 1 (E₁) may be a phone-service-only customer receiving traditional PBX support through multiple DS0 or DS1 lines. Enterprise 2 (E₂), on the other hand, may be a combined data and telephony customer receiving both IP support provided by an edge router and PBX support through multiple DS0 or DS1 lines and a DS1 or Ethernet handoff. Furthermore, Enterprise n (Eₙ) may be a data-service-only customer receiving IP support provided by an edge router through a DS1 or Ethernet handoff. In most cases, the carrier is responsible for managing various PBXs, edge routers, etc. for the enterprise(s).

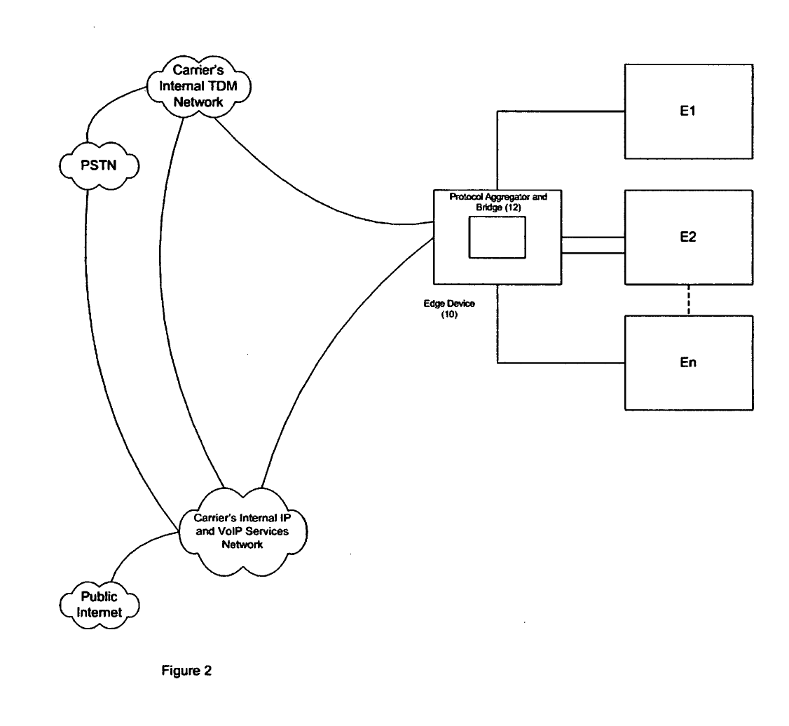

FIG. 2 represents, in block diagram form, a general carrier network architecture according to the principles of the present invention. Note the aggregation of input IP and TDM signals within the edge device (10) to concurrently support different needs on the enterprise side. (In this example, E₁, E₂ and Eₙ receive similar services as those mentioned in FIG. 1 except that the combined data and telephony customer may receive IP-PBX support e.g., through an Ethernet switch or punchdown block.) Thus, instead of multiple carrier-input lines or support devices (D), each enterprise (E) may receive IP, VoIP, and/or TDM support such as MGCP, SIP, TDM, H.323, NCS, PCMM, wireless, etc. via a common access point.

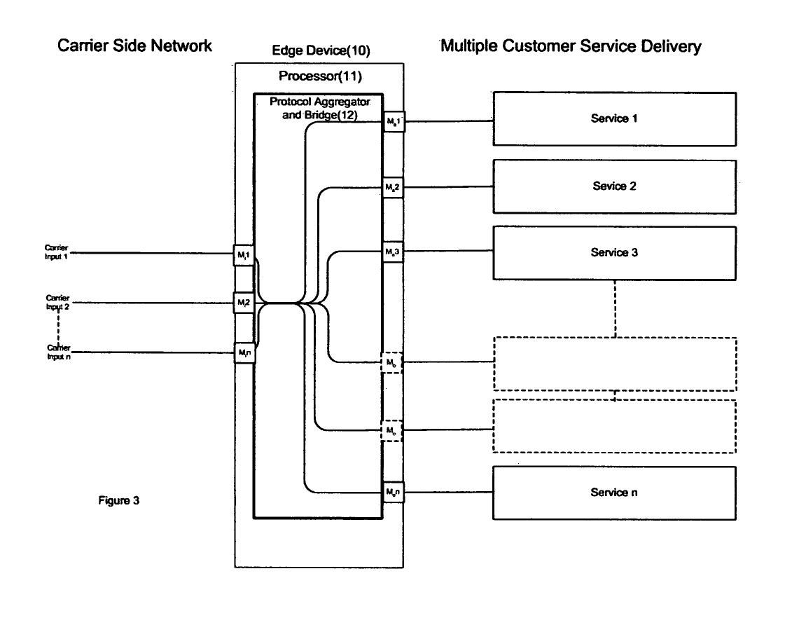

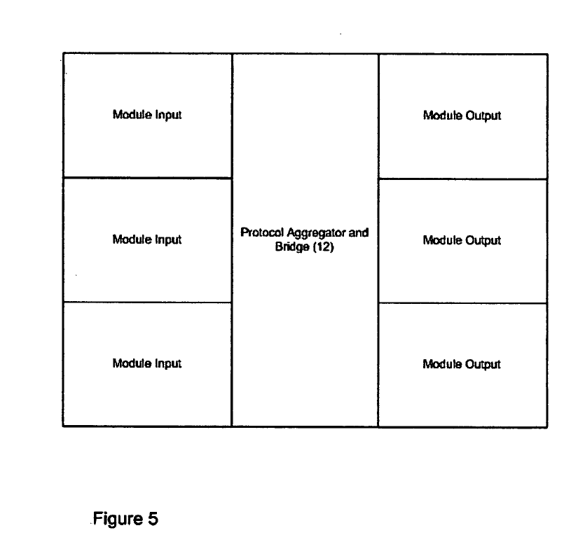

As illustrated in FIG. 3, the edge device (10) generally comprises a processor (11), protocol aggregator and bridge (12), and a plurality of modular input and output modules (shown in FIG. 5). It is to be understood, however, that the edge device (10) is not necessarily limited to these components and may additionally include other interfacing devices as necessary. The processor (11) may comprise one or more CPUs, e.g., such as the ASUS Vintage SIS661 FX chipset pentium 4 Bare System. The protocol aggregator and bridge (12) (discussed in more detail below) in combination with the modular input and output modules allows the edge device (10) to be able to accept any carrier input and provide cross over functionality to support a variety of services on the enterprise side. The edge device (10) is additionally configured with the necessary interface modules to support the desired input and output interfaces depending upon the needs of the carrier and the enterprise(s). Hardware interface modules may be readily obtained through vendors such as Digium™. Examples include, but are not limited to, the Wildcard TDM400P card by Digium™ to support a plurality of POTS lines. Drivers for the interface modules may come standard or may be developed specifically for a particular interface.

For reliability purposes, the edge device (10) is preferably designed to provide 99.999% uptime. Additional features to ensure such reliability include: redundant power supplies, 48V DC power supply (with an option for AC power), plural CPUs, batteries to ensure >4 hours uptime if power is lost, hot swappable components, support for redundancy, failover times of <50 ms when power fails, remote management and monitoring interfaces/GPUs, and support for multiple TDM standards: DS0, DS1, DS3, OC-n.

FIG. 3 also depicts, in block diagram form the Services 1-n that the edge device (10) may be configured to support. Examples of enterprise services may include NxDS0s and NxFXSs or key systems, customer owned PBXs, combined phone and data traffic, hard or soft phones, video and/or data traffic, etc. For example, the carrier may provide SIP on the input side and support traditional PBXs and H.323 terminals for different customers on the enterprise side by simultaneously converting and managing separate TDM and H.323 data streams. It should be understood that these types of services are not meant to be limiting and that the edge device can easily be configured to support additional technologies. In addition, it should be readily appreciated that more than one service may be provided to the same business/enterprise simultaneously.

The edge device (10) is also able to support and route VoIP and IP traffic internal to each enterprise's phone and data network. For example, the edge device (10) may receive signals from the enterprise side and route/redirect the signals to other separate extensions within the enterprise. Thus, it is understood that the voice and data lines on both sides of the edge device (10) are capable of bi-directional communication. This provides a more direct solution for both the carrier and business where, for example, phone calls placed on the enterprise side do not need to be unnecessarily directed all the way back to the carrier's network-saving time, network bandwidth and cost.

The protocol aggregator and bridge (12) additionally provides for VoIP and IP routing functionality for each customer. While the input modules function to effectively interface with the many different networks on the carrier side, protocol aggregator and bridge acts serves to dynamically bridge between the diverse carrier inputs and enterprise needs. The protocol aggregator and bridge preferably utilizes a unique combination of proprietary and/or open-source software modules run, for example, on LINUX. In order to manage different input protocols, it is desirable to use software modules that are able to mitigate the protocol requirements necessary to deliver substantially diverse services to business complexes, enterprises, etc. Moreover, it is desirable to use robust VoIP software modules that can be configured to support multiple protocols and/or simultaneous data streams and be readily updated to include any newly developed or additional protocols. For example open-source software that is able to meet some or all the above requirements may include, “Asterisk” sponsored by Digium™, “SIPx”, or “Bayonne” by Dialogic.

Asterisk, for example, is highly flexible software that runs on LINUX and provides full PBX functionality. Asterisk supports VoIP in many protocols and interoperates with almost all standards-based telephony equipment. With respect to call features, Asterisk provides typical services such as voicemail, conference bridging, call detail records (CDRs) and many more. Asterisk supports SS7, SIP, H.323 and MGCP protocols and uses an internal protocol to merge voice and data traffic. Asterisk also supports US and European standard signaling types allowing it to bridge between next generation voice-data integrated networks and existing infrastructure. One disadvantage of Asterisk is that it runs on “flat” input configuration files that typically must be manually updated. According to one aspect of the invention, a real-time database is provided to configure the inputs received by the edge device in real time and on-the-fly. The real time database may be written, for example, in MySQL and interfaces low level drivers with the protocol aggregator and bridge. MySQL is a multi-threaded, multi-user structured query language database management system and works with e.g., LAMP (LINUX/Windows-Apache-MySQL-PHP/Perl/Python) platforms. MySQL-based databases are also useful in VoIP environments for storing SIP user-agent client (UAC) passwords and account and usage information (e.g., CDRs). In addition, the real time database manages the plurality of configuration files simultaneously and enables parameters to be changed and/or updated in real time and on-the fly.

According to a further embodiment of the present invention, an input module to interface with DOCSIS®/PacketCable™ 1.x or 2.x inputs is provided. The input module may include a physical coaxial or Ethernet connector interface as well as software drivers. Custom driver interfaces comprising database specific code and/or generic function calls are provided specifically for DOCSIS®/PacketCable™ inputs to comply with CableLabs® specifications. The edge device further provides configuration for the DOCSIS® inputs which may be implemented and managed e.g., by the real time database. If necessary, the edge device may also incorporate provisioning software, eMTAa and/or modems (not shown), in the form of hardware and/or software.

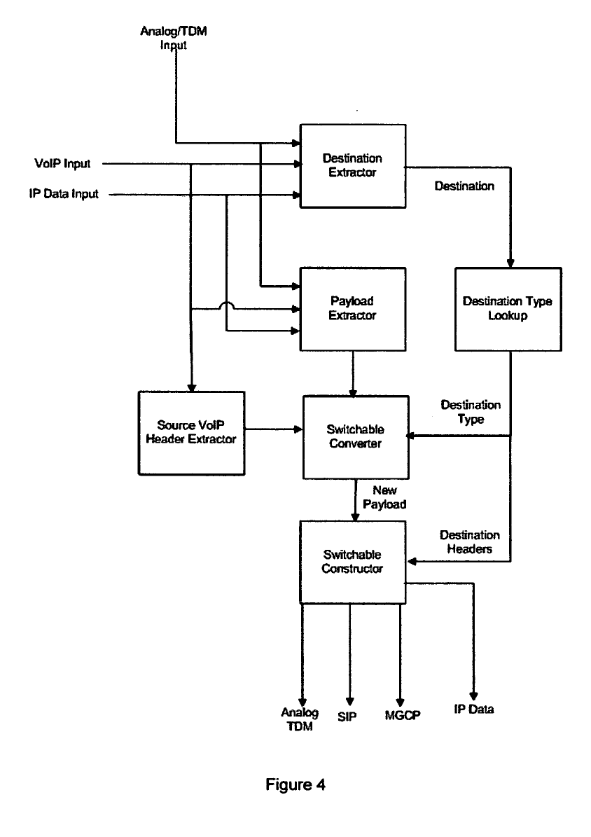

Turning now to FIG. 4, the logical functions of the protocol aggregator and bridge (12) are represented by the illustrated flowchart with respect to one or more data streams and will now be described in more detail. As can be seen on the left-hand side of the figure, any or all of TDM, IP and/or VoIP carrier signal formats or their equivalents may be received as inputs and directed to the protocol aggregator and bridge (12). In one embodiment, the edge device (10) is able to receive any one or more of these signal formats while supporting diverse output signal formats simultaneously. The protocol aggregator and bridge (12) functions to concurrently direct and route multiple input data streams based on their determined output destinations and/or services and to dynamically direct multiple streams to their output destinations. For example, one or more inputs are provided to the protocol aggregator and bridge (12) wherein each IP, VoIP or analog/TDM signal may be directed to a Destination Extractor, Payload Extractor and, in the case of VoIP, Source VoIP Header Extractor. The Source VoIP Header Extractor identifies the type of protocol based upon the protocol header within the packet The Destination Extractor identifies the destination fields of the respective messages and looks up the type of destination service in a Destination Type database, for example. The Destination Type database may further manage customer requirement information (e.g., number of users, equipment models, etc.) in real time. The Payload Extractor strips the data payload from the packet to be subsequently encapsulated into another protocol if necessary, for example SIP. In addition, any incoming analog signals are identified. The analog signals are converted into a digital payload if the destination is digital and vice versa and subsequently encapsulated as necessary. The Switchable Converter and Switchable Constructor function to reformat the payload according to conventional techniques.

As shown in FIG. 5, the edge device (10) is able to interchangeably receive at least one or more input modules (mᵢ₁₋ₙ) for receiving different carrier inputs. In addition, the device is also able to interchangeably receive at least one or more output modules (mₒ₁₋ₙ) adapted for supporting diverse enterprise services. The hardware modules may include network interface cards and/or digital signal processors incorporated thereon or alternatively such processing may be performed in software. Although termed “input” and “output” modules for illustration purposes, it is understood that the edge device (10) is intended to provide bi-directional data flow and functionality between the carrier and enterprise(s). Again, a modular philosophy is important since it will allow for far more versatility when deploying the edge device (10). In another preferred embodiment, all of the interchangeable modules are hot-swappable so that removal of one does not affect operation of the others or require re-booting of the entire system.

Another aspect of the present invention includes an intuitive graphical user interface (GUI) configured to manage the edge device (10) and provide easy configuration of equipment at the business or enterprise location. The object of the graphical user interface is to allow the creation of multiple extensions, bridging of multiple protocols, setting up Internet connections, etc. in a user-friendly format. Ease of use of a GUI that allows for rapid personnel training is an imperative design requirement for managing the protocol aggregator in terms of time and cost to the business or enterprise. In addition, the GUI also preferably allows for powerful remote managing of devices, remote monitoring capability and generation of verbose log files.

A further desirable feature is a back-up battery associated with the edge device (10) in order to provide seamless service to multiple users and graceful recovery in the event of a power outage. In one embodiment, the back-up battery is encompassed within the edge device (10).

As VoIP becomes more prevalent, it is anticipated that carriers will continue to use combinations of MGCP, PacketCable™, SIP, H.323, and TDM, etc. to deliver services to businesses, enterprises, office complexes, etc. In such environments, where needs are so diverse and in flux, the edge device (10) is advantageously able to simultaneously support multiple IP and TDM conversions in order to meet these future demands. For example, the edge device (10) is capable of accepting a variety of VoIP protocols such as SIP, MGCP, H.323, PacketCable™, TDM, etc. delivered over various transportation technologies including T1, Metro Ethernet, DOCSIS®, GSM, WiFi, etc. In addition, the present invention is able to interface with more than one type of carrier input at a time. For example, the edge device can accept as well as provide cross-over functionality for any of TDM, DOCSIS®/PacketCable™ and Ethernet (wireline and wireless) inputs simultaneously.

Although preferred embodiments of the invention have been described herein, it is to be understood that the invention is not limited to these embodiments, and that various changes and modifications thereto may be made without departing from the scope or spirit of the invention.

1. A carrier-indiscriminate device located at the edge of a customer premises providing telecommunications support for one or more customers, comprising:
one or more input modules capable of receiving data streams associated with a variety of carrier inputs;
a processor comprising: a protocol aggregator and bridge that provides protocol translation and manages and directs the one or more data streams to appropriate output module(s) on the device based on the identified customer and/or type of output service; and
wherein desired telecommunications support is provided to the one or more customers via the output module(s).

2. The device of claim 1, wherein the one or more customers include one or more enterprises.

3. The device of claim 2, wherein the device supports concurrent PBX services for multiple enterprises.

4. The device of claim 1, wherein the carrier input(s) include one or more inputs associated with: SIP, H.323, MGCP, MEGACO, cable, DSL, wireless, and/or TDM.

5. The device of claim 1, wherein the processor configures one or more inputs simultaneously.

6. The device of claim 1, wherein the processor includes a database that configures the one or more inputs in real time and/or on-the-fly.

7. The device of claim 1, wherein the processor includes a database that manages customer requirement information in real time.

8. The device of claim 1, wherein the protocol aggregator and bridge concurrently manages and/or directs the one or more data streams.

9. The device of claim 1, wherein the protocol aggregator and bridge provides simultaneous protocol translation for one or more data streams.

10. The device of claim 1, wherein the device is capable of supporting: analog phones, soft phones, hard phones, IP-PBXs, analog PBXs, H.323 terminals, SIP-based devices, MGCP-based devices, wireless devices, broadband and/or cable equipment.

11. A method for providing diverse telecommunications support for one or more customers using a carrier-indiscriminate device located at the edge of a customer premises, comprising:
providing one or more input modules capable of receiving data streams associated with a variety of carrier inputs;
providing a processor comprising: a protocol aggregator and bridge that provides protocol translation support and manages and directs the one or more data streams to appropriate output module(s) on the device based on the identified customer and/or type of output service; and
providing desired telecommunications support to the one or more customers via the output module(s).

12. The method of claim 11, wherein the one or more customers include one or more enterprises.

13. The method of claim 12, wherein the device supports concurrent PBX services for multiple enterprises.

14. The method of claim 11, wherein the carrier input(s) include one or more inputs associated with: SIP, H.323, MGCP, MEGACO, cable, DSL, wireless, and/or TDM.

15. The method of claim 11, wherein the processor configures one or more inputs simultaneously.

16. The method of claim 11, wherein the processor includes a database that configures the one or more inputs in real time and/or on-the-fly.

17. The method of claim 11, wherein the processor includes a database that manages customer requirement information in real time.

18. The method of claim 11, wherein the protocol aggregator and bridge concurrently manages and/or directs the one or more data streams.

19. The method of claim 11, wherein the protocol aggregator and bridge provides simultaneous protocol translation for one or more data streams.

20. The method of claim 11, the device supporting: analog phones, soft phones, hard phones, IP-PBXs, analog PBXs, H.323 terminals, SIP-based devices, MGCP-based devices, wireless devices, broadband and/or cable equipment.
